(19) United States
(12) Patent Application Publication
(10) Pub. No.: US 2026/0368696 A1
(43) Pub. Date: Nov. 19, 2026

(54) Product Expiration Management with Virtual Warehouse Operation

(71) Applicant: DeRoyal Industries, Inc., Powell, TN (US)

(72) Inventors: Joe L. Smith, Knoxville, TN (US); Tabatha Shuster, Chattanooga, TN (US); Mark E. McKnight, Knoxville, TN (US); Sallie P. Patrick, Maryville, TN (US); Kenneth L. Jones, Lenoir City, TN (US); James W. Tucker, Knoxville, TN (US); Vladimir Rusev, Cumming, GA (US)

(73) Assignee: DeRoyal Industries, Inc., Powell, TN (US)

(21) Appl. No.: 19/659,069

(22) Filed: Apr. 27, 2026

Related U.S. Application Data
(63) Continuation-in-part of application No. 19/207,443, filed on May 14, 2025.

(51) Int. Cl. G06Q 10/087; G06K 7/10

(52) U.S. Cl. CPC G06Q 10/08772; G06K 7/10366; G06Q 10/08726; G06Q 10/08776

(57) ABSTRACT

A system monitors stocking levels of inventory items in inventory storage spaces and redeploys items that are overstocked in a first inventory space to another inventory space. The system, referred to herein as a Virtual Warehouse, includes an inventory computer that executes instructions to determine whether any type of inventory item in the first inventory space is overstocked, and if so, by how much. If it determines that a first type of inventory item is overstocked by some number of items in the first inventory space, the inventory computer either updates an inventory database to add that number to the total number of the first type of inventory items available for fulfilling orders for the other inventory spaces, or it performs operations as needed to redeploy the overstocked inventory items from the first inventory space to the other inventory storage spaces in which the same type of inventory item is understocked.

### FIELD

This invention relates to the use of radio frequency identification (RFID) technology to identify products within multiple facilities in which the products are used, and to access and display information about the identified products. More particularly, this invention relates to use of RFID technology to establish a virtual warehouse in which to display information about products that are overstocked in one or more of the facilities so as to indicate that the overstocked products are available to be ordered and delivered to another of the facilities in which the products are understocked.

### BACKGROUND

Many healthcare systems have multiple facilities at multiple locations, each with multiple departments. Generally, each department at each location keeps an inventory of products needed for patient care. Due to various factors, different facilities and departments may utilize the same product at different rates. Factors affecting product utilization rates include physician preference, patient population, and procedure volume, among others.

A hospital department (e.g., Cath Lab, Interventional Radiology, Surgery, etc.) may have hundreds or thousands of types of products that hospital staff must manage. For some products that are used infrequently, the hospital department may keep only one on the shelf. For other products that are used more frequently, the hospital department may stock several of each product on the shelf. Considering the number of different types of products used in each department, and multiples of many of the products, a hospital may have tens of thousands of individual products that must be managed.

Most products used in procedure areas of a hospital have expiration dates. Manually tracking the expiration dates of thousands or tens of thousands of products requires an enormous amount of effort. As a result, many hospitals end up with products reaching their expiration dates while sitting on the shelf. These expired products represent both a cost to the hospital and a risk to patients. Ideally, expired products are quickly identified and disposed of, and the hospital orders replacements. If expired products are left on the shelf, the expired product could accidentally be used during a patient's procedure. The cost to a hospital of expired products could easily total hundreds of thousands of dollars per year.

Also, due to various reasons, different inventory locations within the same hospital may use particular products at different rates. For example, one inventory location might dispense a particular product several times a month, while another inventory location might dispense the same product only once a year. This is also true between different hospitals.

What is needed, therefore, is a system that creates a virtual warehouse in which medical facilities can redeploy supplies from locations at which the supplies are used at a lower rate to locations at which the supplies are used at a higher rate.

### SUMMARY

The above and other needs are met by an apparatus for monitoring stocking levels of inventory items in inventory storage spaces and for redeploying inventory items that are overstocked in one inventory storage space to another inventory storage space. In a preferred embodiment, the apparatus includes a first inventory storage space associated with a first healthcare facility, one or more other inventory storage spaces associated with the first healthcare facility or a second healthcare facility, an inventory database, a user interface device, and an inventory computer.

The first inventory storage space includes inventory items for use in medical treatment of patients, and RFID tags attached to the inventory items, wherein each RFID tag is encoded with a tag identification number. The first inventory storage space also includes an RFID reader that is operable to scan the first inventory storage space to detect the RFID tags and to acquire tag identification numbers therefrom.

The inventory database associates tag identification numbers with item information.

The user interface device is operable to receive and display item information and/or messages to facility personnel that are related to the inventory items.

The inventory computer is in communication with the inventory database, the RFID reader, and the user interface device via a communication network. In a preferred embodiment, the inventory computer is operable to execute instructions to:
receive the tag identification numbers of RFID tags detected in the first inventory storage space from the RFID reader;
acquire item information associated with the received tag identification numbers from the inventory database;
based on the item information associated with the received tag identification numbers, determine a quantity of each type of inventory item available in the first inventory storage space;
based on the quantities of each type of inventory item available in the first inventory storage space, determine whether any type of inventory item is overstocked in the first inventory storage space; and
based on determining that a first type of inventory item is overstocked by Y number in the first inventory storage space:
   update the inventory database to add Y number to a number of the first type of inventory item available for fulfilling orders for one or more of the other inventory storage spaces; or
   perform operations as needed to redeploy one or more of the Y number of the first type of inventory item from the first inventory storage space to one or more of the other inventory storage spaces in which the first type of inventory item is understocked.

In some embodiments, the inventory computer is further operable to execute instructions to cause the user interface device to display an indication to inventory personnel that the number of the first type of inventory item available for fulfilling orders for one or more of the other inventory storage spaces has increased by Y number.

In some embodiments, the inventory computer is further operable to execute instructions to:
determine whether any type of inventory item is understocked in the first inventory storage space; and
based on determining that a particular type of inventory item is understocked in the first inventory storage space, perform operations as needed to resupply the particular type of inventory item in the first inventory storage space, or to alert inventory personnel via the user interface device of a need to resupply the particular type of inventory item in the first inventory storage space.

In some embodiments, the communication network comprises the Internet and/or a local area network within the first healthcare facility.

In some embodiments, the first inventory storage space comprises a room, closet, vault, or cabinet in which the inventory items are stored prior to removal therefrom for use in medical treatment of patients.

In some embodiments, the RFID reader comprises a handheld RFID scanner or a fixed RFID scanner installed within the first inventory storage space.

In some embodiments, the user interface device is a handheld device comprising a tablet computer, laptop computer, or smart phone that is in wireless communication with the communication network.

In another aspect, some embodiments of the invention provide a method for monitoring stocking levels of inventory items in inventory storage spaces and for redeploying inventory items that are overstocked in a first inventory storage space to one or more other inventory storage spaces. In a preferred embodiment, the method includes:
scanning the first inventory storage space using an RFID reader to detect the RFID tags attached to inventory items disposed in the first inventory storage space;
acquiring item information from an inventory database, wherein the item information is associated with the RFID tags detected within the first inventory storage space; and
executing instructions on an inventory computer in communication with the inventory database, wherein the instructions cause the inventory computer to:
   receive the tag identification numbers of RFID tags detected in the first inventory storage space from the RFID reader;
   acquire item information associated with the received tag identification numbers from the inventory database;
   based on the item information associated with the received tag identification numbers, determine a quantity of each type of inventory item available in the first inventory storage space;
   based on the quantities of each type of inventory item available in the first inventory storage space, determine whether any type of inventory item is overstocked in the first inventory storage space; and
   based on determining that a first type of inventory item is overstocked by Y number in the first inventory storage space:
      update the inventory database to add Y number to a number of the first type of inventory item available for fulfilling orders for the one or more other inventory storage spaces; or
      perform operations as needed to redeploy one or more of the Y number of the first type of inventory item from the first inventory storage space to the one or more other inventory storage spaces in which the first type of inventory item is understocked.

In some embodiments, the inventory computer executes instructions to cause a user interface device to display an indication to inventory personnel that a quantity of the first type of inventory item available for fulfilling orders for one or more of the other inventory storage spaces has increased by Y number.

In some embodiments, the inventory computer executes instructions to:
determine whether any type of inventory item is understocked in the first inventory storage space; and
based on determining that a particular type of inventory item is understocked in the first inventory storage space, perform operations as needed to resupply the particular type of inventory item in the first inventory storage space, or to alert inventory personnel via a user interface device of a need to resupply the particular type of inventory item in the first inventory storage space.

In yet another aspect, some embodiments of the invention provide a method for monitoring stocking levels of inventory items in inventory storage spaces and redeploying inventory items from a first inventory storage space to one or more other inventory storage spaces. A preferred embodiment of the method includes:
scanning the first inventory storage space using an RFID reader to detect the RFID tags attached to inventory items disposed in the first inventory storage space;
acquiring item information from an inventory database, wherein the item information is associated with the RFID tags detected within the first inventory storage space; and
executing instructions using an inventory computer in communication with the inventory database, wherein the instructions cause the inventory computer to:
   receive tag identification numbers of RFID tags detected in the first inventory storage space from the RFID reader;
   acquire item information associated with the received tag identification numbers from the inventory database, wherein the item information includes estimated usage rates and expiration information for the inventory items available in the first inventory storage space;
   based the estimated usage rates and expiration information, determine a likelihood that one or more inventory items of a first type that are available in the first inventory storage space will not be dispensed for use prior to expiration dates for the one or more inventory items of the first type;
   based on determining that one or more inventory items of the first type available in the first inventory storage space will likely not be dispensed for use prior to their expiration dates, determine whether any of the other inventory storage spaces are understocked on inventory items of the first type; and
      based on determining that inventory items of the first type are understocked in at least one of the other inventory storage spaces, perform operations as needed to redeploy the inventory items of the first type from the first inventory storage space to the other inventory storage space, or
      based on determining that inventory items of the first type are not understocked in at least one of the other inventory storage spaces, update the inventory database to designate the inventory items of the first type in the first inventory storage space as available as needed for fulfilling orders to resupply inventory items of the first type in the other inventory storage spaces.

### BRIEF DESCRIPTION OF THE DRAWINGS

Other embodiments of the invention will become apparent by reference to the detailed description in conjunction with the figures, wherein elements are not to scale so as to more clearly show the details, wherein like reference numbers indicate like elements throughout the several views, and wherein:

FIG. 1 depicts a product expiration management and risk mitigation system according to an embodiment of the disclosure;

FIG. 2 depicts components of a product expiration management and risk mitigation system disposed at an inventory space according to an embodiment of the disclosure;

FIG. 3 depicts a method for managing product expiration and mitigating risk according to an embodiment of the disclosure; and

FIGS. 4-6 depict methods for implementing virtual warehouse functions according to embodiments of the disclosure.

### DETAILED DESCRIPTION

As the term is used herein, an “inventory item” or “product” is any item of inventory that is provided by a vendor and kept in inventory until the item is consumed or otherwise disposed of. In some embodiments described herein, an inventory item may be a “medical item,” which is an item, device, material, substance, or piece of durable medical equipment (DME) that is kept in inventory in a medical facility until it is used or consumed during the performance of a medical procedure or dispensed to a patient to treat a medical condition or provide comfort to the patient. For example, sponges, gloves, and drapes are medical items. Surgical implants, knee braces, negative pressure wound therapy units, blood glucose monitors, and wheelchairs are further examples of medical items.

Each inventory item has a catalog number that may be referred to when placing an order for some quantity of the item. For example, a box of gloves has a catalog number. Inventory items are often referred to using SKUs (Stock Keeping Units). If someone says they have 1,000 SKUs, this means their inventory includes 1,000 different catalog numbers that identify 1,000 different types of inventory items. One unit of an inventory item, such as one box of gloves, is referred to herein as an individual inventory item or an individual product.

Each individual inventory item may also have a unique identifier, such as an Electronic Product Code (EPC), that is encoded in an RFID tag attached to the item or its packaging. In a preferred embodiment, the RFID tag is embedded in a single adhesive label that is attached to the item or its packaging. As the term is used herein, a “scan” for RFID tags refers to operations performed by an RFID reader to transmit signals and receive signals from RFID tags that are in range of the RFID reader and its associated antenna(s).

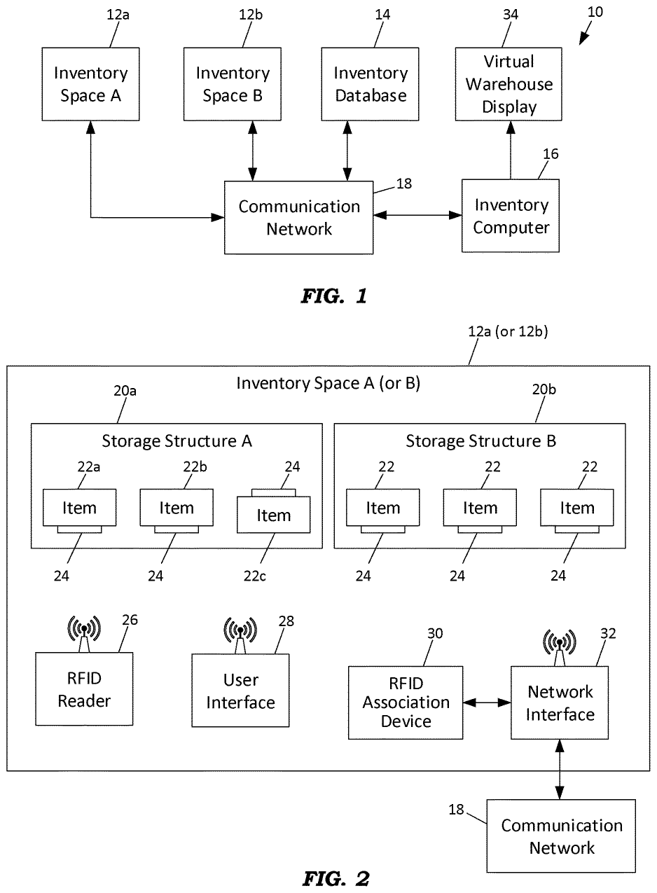

As shown in FIG. 1, a preferred embodiment of a product expiration management and risk mitigation system 10 includes a first inventory space 12a (also referred to as inventory space A), a second inventory space 12b (also referred to as inventory space B), an inventory database 14, a central inventory computer 16, and a communication network 18. The inventory spaces 12a-12b are storage spaces, such as rooms, closets, vaults, and cabinets, in which an inventory of items is stored until the items are removed. In one embodiment, the inventory spaces 12a-12b are separate rooms in which medical items are stored within one healthcare facility. For example, the inventory spaces 12a-12b may be in a Cath Lab department, an Interventional Radiology department, or a Surgery department. In another embodiment, the inventory spaces 12a-12b are in two separate healthcare facilities that may be in different regions of the country.

The inventory database 14 contains information regarding individual inventory item, such as information that associates the tag identification number of an individual inventory item with its SKU, information indicating the expiration date of the individual inventory item, and information identifying an inventory space in which the individual inventory item is stored.

The central inventory computer 16 may be a server computer, desktop computer, laptop computer, or other computing device. The inventory computer 16 includes memory for storing and a processor for executing instructions to communicate with the inventory database 14 to update and maintain inventory records, and communicate with facility personnel as described in more detail herein.

The communication network 18 may comprise a wide area network, such as the Internet, and/or a local area network within a particular healthcare facility. In the preferred embodiment, the first and second inventory spaces 12a-12b, the inventory database 14, and the central inventory computer 16 all include network interface devices that allow them to communicate with each other via the communication network 18.

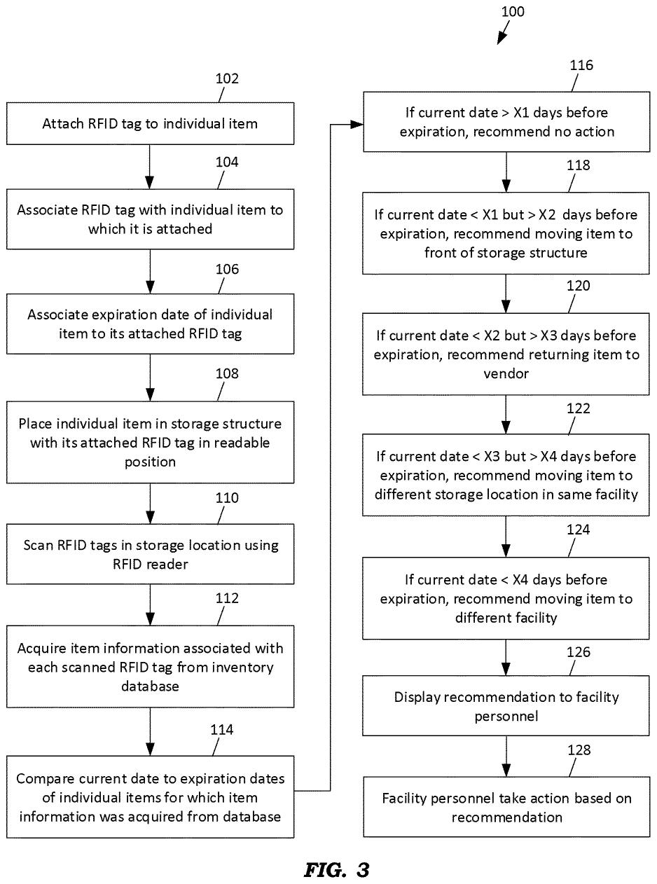

FIG. 2 depicts components of a preferred embodiment of the first inventory space 12a. It will be appreciated that the second inventory space 12b may include the same or similar components, although it will not have the same inventory of individual inventory items as the first inventory space 12a. As shown in FIG. 2, the first inventory space 12a includes one or more storage structures 20a-20b that each contain individual inventory items 22. In a preferred embodiment, the storage structures 20a-20b comprise shelving units on which the items 22 are placed. In some embodiments, the storage structures 20a-20b include bins in which the items 22 are contained, and the bins are placed on the shelving units. An RFID tag 24 is attached to each individual inventory item 22.

In a preferred embodiment, each inventory space 12a-12b includes an RFID reader 26, which may be a handheld RFID scanner such as the model RFD40 UHF RFID Premium manufactured by Zebra Technologies Corporation. In some embodiments, one or multiple RFID readers 26 may be carried around by facility personnel from one inventory space to another within the healthcare facility for use therein. Preferably, each RFID reader 26 is wirelessly connected to a network interface 32, such as via a WiFi link, and the network interface 32 is connected to the communication network 18. Each inventory space 12a-12b is preferably equipped with at least one mobile user interface device 28, which may be a tablet computer, laptop computer, or smart phone that is wirelessly connected to a network interface 32.

In a preferred embodiment, each inventory space 12a-12b also includes an RFID association device 30, such as the model 47940911 Continuum Encoding Station Utility manufactured by DeRoyal Industries Inc. The RFID association device 30 is used to encode each RFID tag 24 with the EPC of the individual inventory item 22 to which the tag 24 is or will be attached. The RFID association device 30 is also operable to communicate with the inventory database 14 via the network interface 32 and the communication network 18, so that the tag ID of the RFID tag 24 can be stored in the database 14 in association with the EPC of each individual inventory item 22 and other item information. In a second embodiment, a unique tag identification number is stored in the tag's user memory. In a third embodiment, the tag's Tag ID is read from the tag and used as the tag identification number.

It will be appreciated that care must be taken to properly attach each RFID tag 24 to its associated individual inventory item 22 in a manner that will maximize the probability that the tag 24 will be readable by the RFID reader 26 when the tagged item is disposed within the storage structure 20a-20b. This involves choosing a surface of the item 22 or its packaging that is most likely to be in a readable orientation with respect to the RFID reader 26 when multiple items 22 are arranged together within the storage structure 20a-20b. For example, even though the RFID reader 26 is not an optical device, there is a higher probability that the reader 26 will be able to accurately read an RFID tag 24 if there is a clear line-of-sight between the reader 26 and the tag. As an illustration of this point, the two items 22a and 22b on the left side of the storage structure 20a in FIG. 2 are properly oriented with their RFID tags 24 facing outward with a clear line-of-sight to the reader 26. In contrast, the tag 24 on the item 22c on far-right side of the storage structure 20a does not have a clear line-of-sight to the reader 26. As a result, there is a lower probability that the tag 24 on the item 22c will be successfully read. Another consideration is the choice of an RFID tag having a size and shape that is compatible with the size and shape of the surface of the item 22 that will have a clear line-of-sight to the reader 26 when the item 22 is disposed on the storage structure 20a.

FIG. 3 depicts steps of a method 100 that may be carried out using the system shown in FIGS. 1 and 2 to manage product expiration and mitigate risk. The method 100 includes facility personnel attaching individual RFID tags 24 to the individual inventory items 22 or their packaging (step 102). As discussed above, the selection of the surfaces to which the tags 24 will be attached and the selection of the size and configuration of the tags 24 can affect the successful reading of the tags 24 by the RFID tag reader 26. The RFID association device 30 is used to encode each RFID tag 24 with an EPC, and store the EPC in the inventory database 14 in association with information about the individual inventory item 22 to which the tag 24 is attached (step 104). In some embodiments, this may involve reading the Tag ID of the tag 24 and storing the Tag ID in the inventory database 26 in association with other information about the individual inventory item 22. In some embodiments, step 104 may be performed before or after step 102. In step 106, information indicating the expiration date of the individual inventory item 22 is associated in the inventory database 14 with the Tag ID, the EPC, or both. Once the item 22 has been tagged, it is placed in the storage structure 20a or 20b with its RFID tag 24 in a proper position for successful reading (step 108). In another embodiment, a unique tag identification number is stored in the tag's user memory instead of the Tag ID or EPC.

From time to time, facility personnel will use the RFID tag reader 26 to scan the inventory of items in each inventory space 12a-12b (step 110). For each RFID tag 24 detected during a scan, the inventory computer 16 accesses the inventory database 14 to acquire item information associated with each detected RFID tag 24 (step 112). In preferred embodiments, the item information includes expiration dates of individual inventory items 22. For each tag 24 detected in the inventory space 12a-12b, the inventory computer 16 compares the item expiration date to the current date (which is preferably the date the tag 24 is detected), and determines how many days remain until the expiration date (step 114).

In preferred embodiments, the system 10 generates a recommendation for action that facility personnel should take with regard to each individual inventory item 22 detected within the inventory space 12a-12b, wherein the recommendation is based at least in part on the number days remaining until the expiration date of the individual inventory item 22. For example:
If there are more than X1 days until expiration, the recommendation may be to take no immediate action, so that the individual inventory item 22 remains in its current position within the inventory space 12a-12b (step 116).
If there are fewer than X1 days but greater than X2 days until expiration, the recommended action may be to move the individual inventory item 22 to a front position, or top position, or otherwise most assessable position on the storage structure 20a-20b (step 118).
If there are fewer than X2 days but greater than X3 days until expiration, the recommended action may be to return the individual inventory item 22 to the product's vendor for replacement or refund (step 120).
If there are fewer than x3 but greater than X4 days until expiration (which means that at least some of the previously recommended actions were either not taken or not needed), the recommended action may be to move the individual inventory item 22 to another inventory space 12a-12b within the same healthcare facility where overall demand for the item is greater (step 122).
If there are fewer than X4 days until expiration (which means that at least some of the previously recommended actions were either not taken or not needed), the recommended action may be to ship the individual inventory item 22 to another healthcare facility where overall demand for the item is greater (step 124).

In some embodiments, X1=180, X2=120, X3=90, and X4=60.

In some embodiments, healthcare systems may skip some of the generated action steps. For example:
Some healthcare systems may elect to not move soon-to-expire items to a front position, or top position, or otherwise most assessable position on the storage structure.
Some healthcare systems may elect to focus efforts towards returning products to vendors for replacement or refund. In these embodiments the only recommended actions may be to return products to vendors.
Some healthcare systems may elect to vary the recommended actions based on the inventory item. For example, all possible actions may be recommended for some inventory items, no actions may be recommended for some inventory items, only one action may be recommended for some inventory items, only two actions may be recommended for some inventory items, etc.

In preferred embodiments, the recommendation for action is included in an electronic message that is transmitted to and displayed on the user interface device 28 (step 126), which prompts facility personnel to take the recommended action (step 128).

In some embodiments, the RFID reader 26 is a fixed device that is installed within the inventory space 12a-12b, and it is automatically activated periodically to scan for RFID tags 24. In this case, the inventory computer 16 compares the current date to item expiration dates associated with the detected tags, determines how many days remain until the associated individual items expire, and generates recommendations for action accordingly. The action recommendations may be provided to facility personnel via email or other messaging application.

Thus, in preferred embodiments, the inventory computer 16 determines a recommended action based at least in part on timing rules regarding when to take each action. In some embodiments, the inventory computer 16 may also determine a recommended action based at least in part on the cost of the individual inventory item 22, the cost to deliver or relocate the individual inventory item 22, and the relative risk of the individual inventory item 22 expiring in another inventory space 12a-12b or another healthcare facility.

### Virtual Warehouse

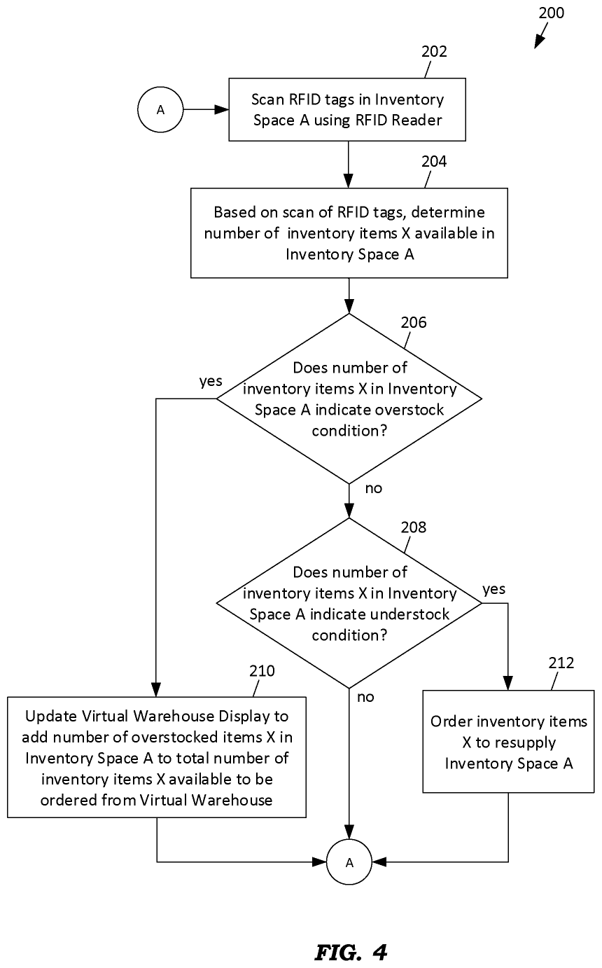

One preferred embodiment described herein the inventory computer 16 executes software instructions to provide a virtual warehouse to which medical facilities can redeploy inventory items from locations at which the items are used at a lower rate to locations at which the items are used at a higher rate. In this embodiment, the inventory computer 16 generates a user interface 34 referred to herein as a virtual warehouse display, as depicted in FIG. 1. As the name implies, the virtual warehouse is not a physical space in which supplies are stored, but is rather a database for listing inventory items that have been designated as overstocked in one or more storage rooms at various medical facilities, and are available to be redeployed to one or more storage rooms at other medical facilities in which those same items are understocked. FIGS. 4, 5, and 6 depict processes carried out by the inventory computer 16 to implement the virtual warehouse functions and generate the virtual warehouse display 34.

FIG. 4 depicts steps of a method 200 that may be carried out using the system shown in FIG. 1 to monitor an inventory storage space A, also referred to herein as the first inventory storage space 12a, to detect overstocked and understocked inventory items and to redeploy or resupply those items as needed. From time to time, facility personnel will use the RFID tag reader 26 to scan the inventory of items in the inventory storage space 12a (step 202). Based on the RFID tags detected during a scan, the inventory computer 16 determines how many of each type of inventory item-such as inventory item X-are available in the inventory storage space 12a and updates the inventory database 14 accordingly (step 204). If the number of detected items indicates that inventory storage space 12a is overstocked on inventory item X (step 206), the inventory computer 16 updates the virtual warehouse to add the number of overstocked items X in inventory storage space 12a to the total number of inventory items X that are available to be deployed elsewhere (step 210). If the number of detected items indicates that inventory storage space 12a is understocked on inventory item X (step 208), the inventory computer 16 performs operations as needed to resupply inventory item X in inventory storage space 12a, or to alert the responsible personnel of the need to resupply inventory item X (step 212).

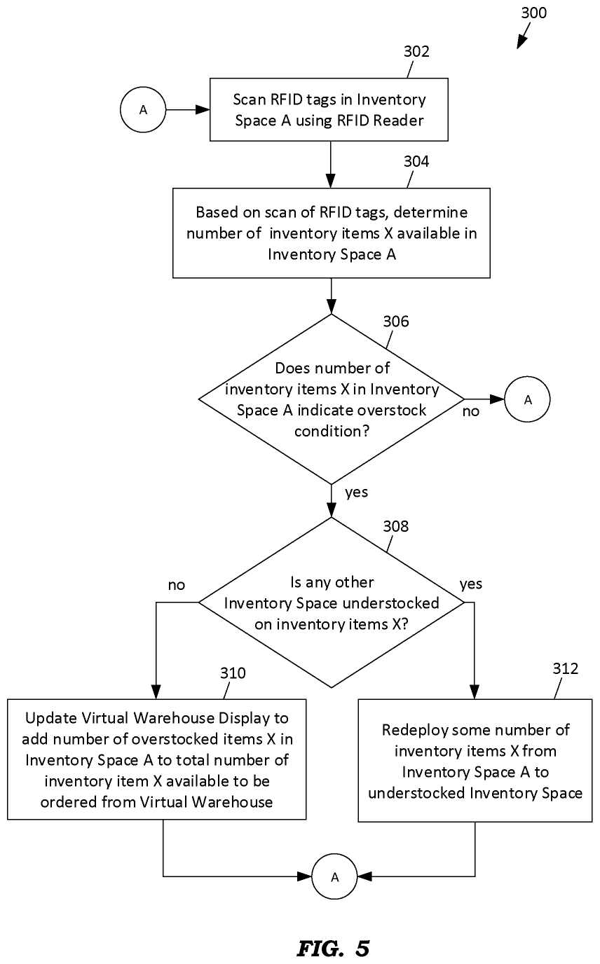

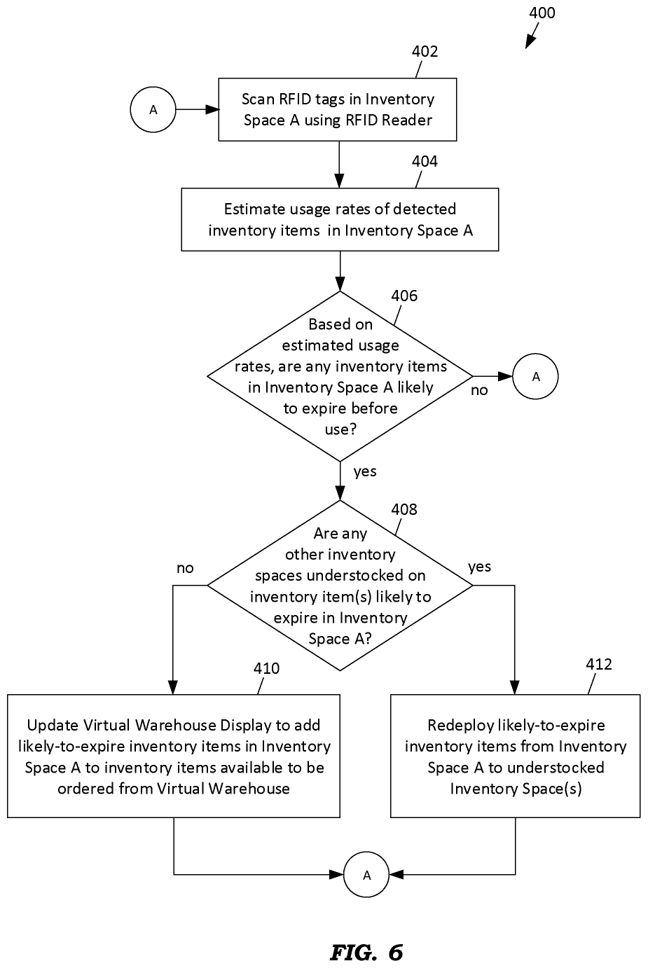

FIG. 5 depicts steps of another method 300 that may be carried out using the system shown in FIG. 1 to monitor the first inventory storage space 12a, to detect overstocked inventory items and to redeploy those items as needed. The facility personnel use the RFID tag reader 26 to scan the inventory of items in the inventory storage space 12a (step 302), and based on the RFID tags detected during the scan, the inventory computer 16 determines how many of each type of inventory item-including inventory item X-are available in the inventory storage space 12a and updates the inventory database 14 accordingly (step 304). If the number of detected items indicates that inventory storage space 12a is overstocked on inventory item X (step 306), the inventory computer 16 accesses the inventory database 14 to determine whether any other inventory storage spaces are understocked on inventory item X (step 308). If one or more other inventory storage spaces are found to be understocked, the inventory computer 16 performs operations as needed to redeploy some number of inventory items X from inventory storage space 12a to the understocked inventory storage space(s), or to alert the responsible personnel of the need to redeploy the overstocked inventory items X (step 312). If no other inventory storage spaces are found to be understocked on inventory item X (step 308), the inventory computer 16 updates the virtual warehouse to add the number of overstocked items X in inventory storage space 12a to the total number of inventory items X that are available to be deployed elsewhere (step 310).

FIG. 6 depicts steps of another method 400 that may be carried out using the system shown in FIG. 1 to monitor the first inventory storage space 12a, to determine usage rates of inventory items, and to redeploy any items that are expected to reach their expiration date before use. The facility personnel use the RFID tag reader 26 to scan the inventory of items in the inventory storage space 12a (step 402), and based on the RFID tags detected during the scan, the inventory computer 16 accesses information from the inventory database 14 to determine the estimated rates at which the detected inventory items are removed from inventory storage space 12a for use in the medical facility in the normal course of operations (step 404). Based on the estimated usage rates, the inventory computer 16 then determines whether any inventory items in inventory storage space 12a are likely to reach their expiration date before being removed for use in the medical facility (step 406). If any of the inventory items are likely to reach their expiration date before being removed for use, the inventory computer 16 accesses information from the inventory database 14 to determine whether any other inventory storage spaces are understocked on the same types of inventory items are likely to expire before being removed for use from inventory storage space 12a (step 408). If other inventory storage spaces are understocked on the same types of inventory items that are likely to expire before being removed for use from inventory storage space 12a, the inventory computer 16 performs operations as needed to redeploy some number of the likely-to-expire inventory items from inventory storage space 12a to the understocked inventory storage space(s), or to alert the responsible personnel of the need to redeploy the likely-to-expire inventory items X (step 412). If no other inventory storage spaces are understocked on the same types of inventory items that are likely to expire before being removed for use from inventory storage space 12a (step 408), the inventory computer 16 updates the virtual warehouse to add the number of likely-to-expire items in inventory storage space 12a to the total number of inventory items of the same type that are available to be deployed elsewhere (step 410).

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An apparatus for monitoring stocking levels of inventory items in inventory storage spaces and for redeploying inventory items that are overstocked in one inventory storage space to another inventory storage space, the apparatus comprising:
a communication network for transferring item information regarding the inventory items;
a first inventory storage space associated with a first healthcare facility, the first inventory storage space comprising:
a plurality of inventory items for use in medical treatment of patients;
a plurality of RFID tags, each attached to a corresponding one of the plurality of inventory items, and each RFID tag encoded with a tag identification number;
an RFID reader that is operable to scan the first inventory storage space to detect one or more of the plurality of RFID tags and acquire one or more tag identification numbers therefrom, the RFID reader in communication with the communication network; and
one or more other inventory storage spaces associated with the first healthcare facility or a second healthcare facility;
an inventory database that associates tag identification numbers with item information, wherein the inventory database is in communication with the communication network;
a user interface device that is operable to receive and display one or more of item information and messages to facility personnel, the item information and messages related to one or more of the inventory items, wherein the user interface device is in communication with the communication network; and
an inventory computer in communication with the inventory database, the RFID reader, and the user interface device via the communication network, the inventory computer operable to execute instructions to:
receive from the RFID reader the tag identification numbers of RFID tags detected in the first inventory storage space;
acquire from the inventory database item information associated with the received tag identification numbers;
based on the item information associated with the received tag identification numbers; determine a quantity of each type of inventory item available in the first inventory storage space;
based on the quantities of each type of inventory item available in the first inventory storage space, determine whether any type of inventory item is overstocked in the first inventory storage space; and
based on determining that a first type of inventory item is overstocked in the first inventory storage space by Y number:
update the inventory database to add Y number to a number of the first type of inventory item available for fulfilling orders for the one or more other inventory storage spaces; or
perform operations as needed to redeploy one or more of the Y number of the first type of inventory item from the first inventory storage space to the one or more other inventory storage spaces in which the first type of inventory item is understocked.

2. The apparatus of claim 1 wherein the inventory computer is further operable to execute instructions to cause the user interface device to display an indication to inventory personnel that the number of the first type of inventory item available for fulfilling orders for the one or more other inventory storage spaces has increased by Y number.

3. The apparatus of claim 1 wherein the inventory computer is further operable to execute instructions to:
determine whether any type of inventory item is understocked in the first inventory storage space; and
based on determining that a particular type of inventory item is understocked in the first inventory storage space, perform operations as needed to resupply the particular type of inventory item in the first inventory storage space, or to alert inventory personnel via the user interface device of a need to resupply the particular type of inventory item in the first inventory storage space.

4. The apparatus of claim 1 wherein the communication network comprises one or both of the Internet and a local area network within the first healthcare facility.

5. The apparatus of claim 1 wherein the first inventory storage space comprises one or more of a room, closet, vault, and cabinet in which the plurality of inventory items are stored prior to removal therefrom for use in medical treatment of patients.

6. The apparatus of claim 1 wherein the RFID reader comprises a handheld RFID scanner or a fixed RFID scanner installed within the first inventory storage space.

7. The apparatus of claim 1 wherein the user interface device is a handheld device comprising a tablet computer, laptop computer, or smart phone that is in wireless communication with the communication network.

8. A method for monitoring stocking levels of inventory items in inventory storage spaces and for redeploying inventory items that are overstocked in a first inventory storage space to one or more other inventory storage spaces, the method comprising:
scanning the first inventory storage space using an RFID reader to detect the RFID tags attached to inventory items disposed in the first inventory storage space;
acquiring item information from an inventory database, the item information associated with the RFID tags detected within the first inventory storage space; and
executing instructions on an inventory computer in communication with the inventory database, the instructions causing the inventory computer to:
receive from the RFID reader the tag identification numbers of RFID tags detected in the first inventory storage space;
acquire from the inventory database item information associated with the received tag identification numbers;
based on the item information associated with the received tag identification numbers; determine a quantity of each type of inventory item available in the first inventory storage space;
based on the quantities of each type of inventory item available in the first inventory storage space, determine whether any type of inventory item is overstocked in the first inventory storage space; and
based on determining that a first type of inventory item is overstocked by Y number in the first inventory storage space:
update the inventory database to add Y number to a number of the first type of inventory item available for fulfilling orders for the one or more other inventory storage spaces; or
perform operations as needed to redeploy one or more of the Y number of the first type of inventory item from the first inventory storage space to the one or more other inventory storage spaces in which the first type of inventory item is understocked.

9. The method of claim 8 wherein the inventory computer executes instructions to cause a user interface device to display an indication to inventory personnel that a quantity of the first type of inventory item available for fulfilling orders for the one or more other inventory storage spaces has increased by Y number.

10. The method of claim 8 wherein the inventory computer executes instructions to:
determine whether any type of inventory item is understocked in the first inventory storage space; and
based on determining that a particular type of inventory item is understocked in the first inventory storage space, perform operations as needed to resupply the
particular type of inventory item in the first inventory storage space, or to alert inventory personnel via a user interface device of a need to resupply the particular type of inventory item in the first inventory storage space.

11. The method of claim 8 wherein the first inventory storage space and the one or more other inventory storage spaces comprise one or more of a room, closet, vault, and cabinet in which the plurality of inventory items are stored prior to removal therefrom for use in medical treatment of patients.

12. A method for monitoring stocking levels of inventory items in inventory storage spaces and redeploying inventory items from a first inventory storage space to one or more other inventory storage spaces, the method comprising:
scanning the first inventory storage space using an RFID reader to detect the RFID tags attached to inventory items disposed in the first inventory storage space;
acquiring item information from an inventory database, the item information associated with the RFID tags detected within the first inventory storage space; and
executing instructions using an inventory computer in communication with the inventory database, the instructions causing the inventory computer to:
receive tag identification numbers of RFID tags detected in the first inventory storage space from the RFID reader;
acquire item information associated with the received tag identification numbers from the inventory database, wherein the item information includes estimated usage rates and expiration information for the inventory items available in the first inventory storage space;
based the estimated usage rates and expiration information, determine a likelihood that one or more inventory items of a first type that are available in the first inventory storage space will not be dispensed for use prior to expiration dates for the one or more inventory items of the first type;
based on determining that one or more inventory items of the first type available in the first inventory storage space will likely not be dispensed for use prior to the expiration dates for the one or more inventory items of the first type, determine whether the one or more other inventory storage spaces are understocked on inventory items of the first type; and
based on determining that inventory items of the first type are understocked in at least one of the other inventory storage spaces, perform operations as needed to redeploy the one or more inventory items of the first type from the first inventory storage space to the at least one other inventory storage space, or
based on determining that inventory items of the first type are not understocked in at least one of the other inventory storage spaces, update the inventory database to designate the one or more inventory items of the first type in the first inventory storage space as available as needed for fulfilling orders to resupply inventory items of the first type in the one or more other inventory storage spaces.

13. The method of claim 12 wherein the first inventory storage space and the one or more other inventory storage spaces comprise one or more of a room, closet, vault, and cabinet in which the plurality of inventory items are stored prior to removal therefrom for use in medical treatment of patients.
